(19) United States
(12) Patent Application Publication
(10) Pub. No.: US 2013/0210331 A1
(43) Pub. Date: Aug. 15, 2013

(54) APPARATUS FOR THE AIR CONDITIONING AND/OR VENTILATION OF AN INTERIOR

(71) Applicant: MAGNA STEYR FAHRZEUGTECHNIK AG & CO. KG, (US)

(72) Inventor: Christoph KRAMMER, Deutschlandsberg (AT)

(73) Assignee: MAGNA STEYR FAHRZEUGTECHNIK AG & CO. KG, Graz (AT)

(21) Appl. No.: 13/742,393

(22) Filed: Jan. 16, 2013

(30) Foreign Application Priority Data
Jan. 17, 2012 (EP) EP 12151418.6

(51) Int. Cl. B60H 1/24

(52) U.S. Cl. CPC B60H 1/245
USPC 454/137

(57) ABSTRACT

An apparatus for the air conditioning and/or ventilation of an interior compartment and which includes an interior trim element on which are configured outflow openings configured to permit air to flow into the interior compartment, the interior trim element including a multilayered structure having a honeycomb core formed of webs between an inner top layer and an outer top layer, adjacent webs being spaced apart from each other to define cavities configured, the webs and cavities combining to form ducts which guide the air in the interior trim element.

### CROSS-REFERENCE TO RELATED APPLICATIONS

The present application claims priority under 35 U.S.C. §119 to European Application EP 12151418.6 (filed on Jan. 17, 2012), which ish hereby incorporated by reference in its entirety.

### TECHNICAL FIELD

An apparatus for the air conditioning and/or ventilation of an interior, such as, for example, an interior compartment of a vehicle, comprising an interior trim element on which is configured outflow openings through which air can be introduced into the interior.

### BACKGROUND

Apparatuses of this type are known and serve, inter alia, for the air conditioning and/or ventilation of the interior of a vehicle. Outflow openings are usually air nozzles or air outlet grilles via which, for example, a temperature-controlled air stream can flow out into the vehicle interior, so as there to help to control the temperature of or ventilate the interior by mixing together with the air that is present. To this end, the outflow openings are connected via ducts to the external air of the vehicle and are generally also connected up to a cooling/heating system of the vehicle.

An apparatus of the generic type is known from DE 198 32 738 A1. In this system, the ceiling of a vehicle has an air distribution chamber, which, with an air discharge wall extending full-facedly in the direction of the superficial extent of the ceiling, adjoins the passenger compartment, wherein the air discharge wall is provided with a multiplicity of finely distributed apertures, through which the air fed to the air distribution chamber by the air supply device enters the passenger compartment.

DE 102 29 042 A1 discloses a device for the release of air into a passenger cell of a vehicle having an extensive air discharge component for diffuse air distribution, which air discharge component forms the at least one visible element of a trim part. The trim part can be a vehicle roofliner, which can consist of a fibre-reinforced plastics plate, a foam layer and a membrane. The plastics plate and the foam layer are perforated with a large number of small holes. A cavity for the guidance of the air is located above the perforated roofliner, i.e. above the air discharge component, so that air can flow out of the cavity into the vehicle interior through the many small holes in the plastics plate and in the foam layer.

### SUMMARY

In accordance with embodiments, provided herewith is an apparatus for the air conditioning and/or ventilation of an interior, such as, for example, an interior compartment of a vehicle, that is manufactured having a compact construction and in a cost-effectively manner.

Embodiments relate to an apparatus for the air conditioning and/or ventilation of an interior, and which includes an interior trim element on which is configured outflow openings through which air are introduced into the interior. The interior trim element is constructed as a multilayered structure having a honeycomb core formed of webs and having at least one uppermost or top inner layer, and whereby cavities are configured between the webs of the honeycomb core as flow ducts for guiding a fluid such as air in the interior trim element, the webs of the honeycomb core forming the boundaries of the ducts.

Embodiments relate to an apparatus having at least one of the following: an interior trim element on which are configured outflow openings configured to permit air to flow into an interior compartment of a vehicle for the air conditioning and/or ventilation of the interior, the interior trim element including a multilayered structure having a honeycomb core formed of webs between an inner top layer and an outer top layer, adjacent webs being spaced apart from each other to define cavities configured, the webs and cavities combining to form ducts which guide the air in the interior trim element.

Embodiments relate to an apparatus having at least one of the following: interior trim element including an inner layer, an outer layer spaced apart from the inner top layer, webs extending in the space between the inner layer and the outer layer, and a cavity formed between adjacent webs, the cavity and the webs defining a duct configured to guide a flow of air in the interior trim element in a direction which is normal to the interior trim element; and an outflow opening provided in the inner layer and configured to permit air to flow into an interior compartment for the air conditioning and/or ventilation of the interior compartment.

Embodiments relate to motor vehicle having at least one of the following: an interior trim element on which are configured outflow openings configured to permit air to flow into an interior compartment of a vehicle for the air conditioning and/or ventilation of the interior, the interior trim element including an inner top layer, an outer top layer spaced apart from the inner top layer, webs extending in the space between the inner top layer and the outer top layer, and a cavity formed between adjacent webs. The cavity and the webs define a duct configured to guide a flow of air in the interior trim element in a direction which is normal to the interior trim element.

In accordance with embodiments, a multilayered structure with a honeycomb core is thus used for the configuration of the interior trim element. The cavities which are present in a multilayered structure with a honeycomb core are used to guide the air for the ventilation or temperature control within the interior trim element. Hence, no additional fittings are needed for the guidance of the air. The webs of the honeycomb core themselves form the ducts through which the air is guided in the interior trim element.

In accordance with embodiments, the ducts for the guidance of the air are configured such that the air is guided normal to the multilayered structure of the interior trim element. Meaning, a movement of the air along the interior trim element is enabled by the ducts in the honeycomb core. The air stream must have at least one significant component normal to the multilayered structure. A guidance of the air flow which in this sense takes place normal to the multilayered structure can also be achieved such that the air flow, for example, is guided in a zigzag, winding, sinusoidal or otherwise meandering path along the interior trim element.

Moreover, a movement or flow of the air will also usually take place in the direction of the multilayered structure, at least at positions at which the air makes its way to the outflow openings at which it exits from the interior trim element.

By virtue of the guidance normal to the multilayered structure, transport of the air along the multilayered structure is achieved. No additional components for guiding the air along the interior trim element are necessary.

In an apparatus in accordance with embodiments, the ducts for guiding the air in the interior trim element are preferably fluidically and/or operatively connected to an air cooling/heating system. If the interior trim element is configured as a roofliner of a motor vehicle, the fluidic connection to an air cooling/heating system can be realized, for example, in the region of the A-, B- or C-pillars of the vehicle.

The apparatus in accordance with embodiments can hence guide temperature-controlled air to the outflow openings and can thus be used to control the temperature of the air in the interior.

In accordance with embodiments, the ducts for guiding the air in the interior trim element are connected to an access path to the external air. It is thereby possible to supply the interior with fresh air. An access path to the external air is usually also necessary for the working of the preferably connected air cooling/heating system.

In accordance with embodiments, the interior is an interior of a vehicle.

In accordance with embodiments, the interior trim element is a vehicle roofliner. This provides a large surface area, which is optimally suited for an agreeable ventilation and/or air conditioning of the interior of a vehicle. In accordance with embodiments, the interior trim element is a floor trim part or a side trim part of a vehicle. The interior trim element can also be used, for example, in aircraft, ships or buildings for the ventilation and/or air conditioning of interiors.

In accordance with embodiments, the honeycomb core is realized as a folding core. Folding cores can be cost-effectively produced and have good characteristics in terms of their stability. The cavities of the folding core form continuous chambers, which run substantially normal to the multilayered structure of the interior trim element. In this way, large, interconnected cavities, which can be used by the apparatus in accordance with embodiments, are provided by a folding core.

In accordance with embodiments, the continuous chambers of the folding core are configured as ducts for the guidance of the air in the interior trim element. By appropriate feeding of the air to the continuous chambers of a folding core, these can be used as ducts through which the air can be guided over further sections along the interior trim element. To this end, no additional steps are necessary in the production of the honeycomb core.

In accordance with embodiments, the honeycomb core is realized as an expansion wave core or as an A-wave core. Traditional configurations of honeycomb cores, for example, in the form of the known honeycombs, are also suitable for embodiments. These geometries have known benefits, in particular in respect of their stability and cost-effective production and finishing, and can be used in accordance with embodiments. In this context, it is advantageous to rework the webs of the honeycomb cores. For example, the webs of the honeycomb core can have apertures for the connection of cavities of the honeycomb core. Thus holes or grooves, for example, can be introduced into the webs of the honeycomb core so as thus to provide ducts for the guidance of the air which are not inherently present in the geometry of the honeycomb core.

In accordance with embodiments, the outflow openings are configured in the inside top layer of the multilayered structure. The outflow openings are preferably arranged distributed over the entire surface of the interior trim element. The outflow openings can be distributed evenly over the whole of the interior trim element. The distribution can also be optimized in accordance with other aspects in order to achieve a ventilation or air conditioning which is comfortable for persons in the interior. For example, the outflow openings in a vehicle roofliner can be arranged in increased density over a seat region of a vehicle in order to obtain good ventilation of the interior region in which the persons usually reside. The outflow openings can also be concentrated in a region of a vehicle in which no seats are arranged, in order to avoid disagreeable draught air for the occupants. To this end, the outflow openings can also have different diameters.

In accordance with embodiments, the multilayered structure is covered on the inside with an air-permeable or perforated material. In this way, the top layer of the multilayered structure is not visible to the vehicle occupants. Outflow openings can be covered by the additional material, whereby the air permeability or perforation serves to ensure that the working of the air conditioning and/or ventilation of the interior is maintained.

In accordance with embodiments, the interior trim element is a part of a seat. The interior trim element can form, for example, a plastics supporting structure for a vehicle seat, which supporting structure is covered by air-permeable foam material and fabric. The air exits from the interior trim element in the seat and thus makes its way directly to the passenger in the interior of the vehicle.

### DRAWINGS

Embodiments are described below, by way of example, with reference to the drawings.

FIG. 1 illustrates a schematic representation of a top view of a trim element in accordance with embodiments.

FIG. 2 illustrates a schematic representation of a side view of the trim element of FIG. 1, normal to the direction of the air supply A.

FIG. 3 illustrates a schematic representation of top view of an interior trim element in accordance with embodiments.

FIG. 4 illustrates a schematic representation of a vehicle having an interior trim element in accordance with embodiments.

### DETAILED DESCRIPTION OF EMBODIMENTS

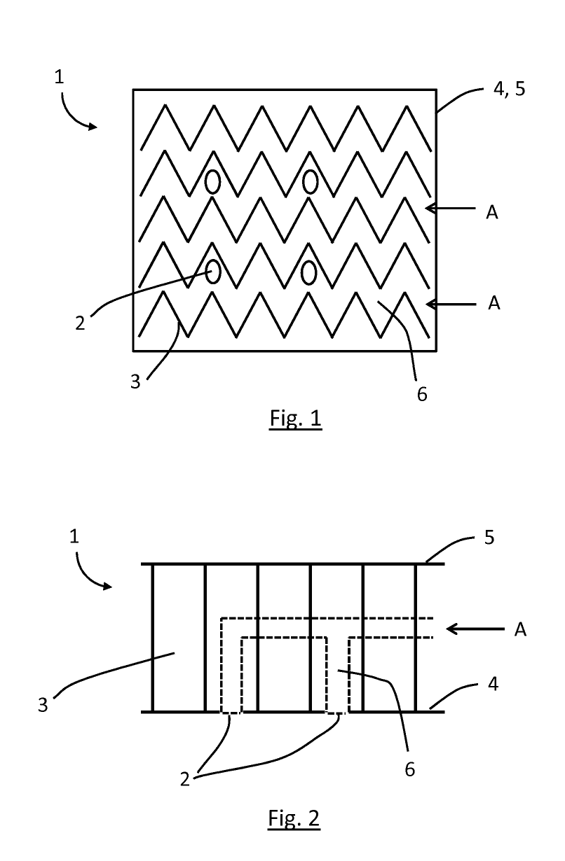

In FIG. 1 is represented an interior trim element 1 in accordance with embodiments which uses a folding core as the honeycomb core. The webs 3 of the folding core extend approximately parallel to one another in zigzag, winding, sinusoidal or otherwise meandering pattern, so that the webs of two different folding layers are spaced apart so as not to touch over long sections. Hence, cavities 6 between adjacent webs define wide-running chambers configured to permit air flow. An air stream which has been laterally introduced in the direction A can therefore flow along the represented chambers largely unhindered by the interior trim element 1.

The honeycomb core is bounded by a pair of top honeycomb layers: an inner top layer 4 and an outer top layer 5, which in the view of FIG. 1 coincide. Provided on or extending through the inner top layer 4 at certain regions are outflow openings 2 configured to permit the exit or discharge of the air from the interior trim element 1 in a direction normal to the direction of the air supply A and normal to the layer structure of the multilayered structure in order to flow into an interior of the vehicle.

Both the honeycomb core, and/or its webs 3, and/or the top layers 4, 5 can be composed of a variety of materials, such as for example, paper, board, plastic, fibre-reinforced plastic, metals or composites thereof. The fibre-reinforced materials can be composed of fibrous material, such as for example, long fibres, fleeces, non-woven fabrics or woven fabrics and can use resin, polyurethane and similar, for example, as a matrix.

FIG. 2 shows in schematic representation an interior trim element 1 in a side view, so that the multilayered structure made up of the inner top layer 4, webs 3 of the honeycomb core, and the outer top layer 5 is clearly discernible. The air flows into the multilayered structure in the direction A and flows, approximately as represented by the dashed lines, along the interior trim element 1 and onward to the outflow openings 2. If the honeycomb core, like the folding core of FIG. 1, is designed with continuous chambers, then it is not necessary to make additional apertures on the webs 3. Even in the case of a folding core, however, it may be expedient to form apertures, for example, normal to the path of the existing continuous chambers in order to enable or increase the air exchange between the individual folding layers.

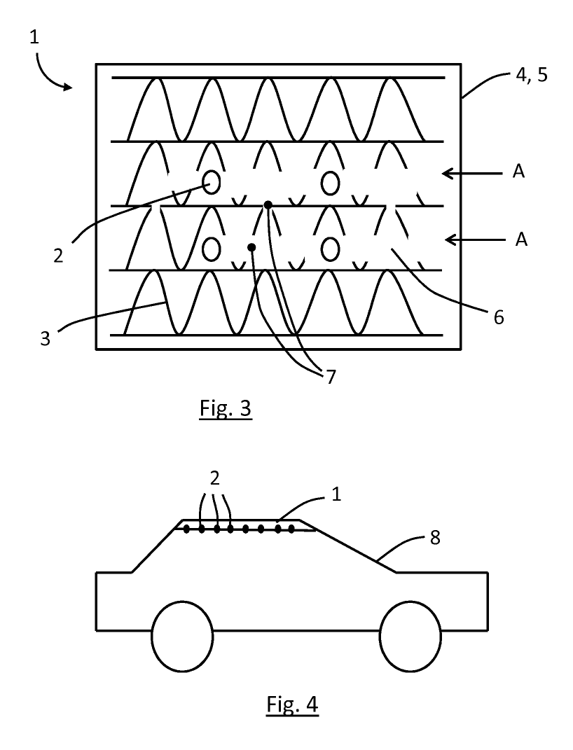

As illustrated in FIG. 3, a traditional honeycomb core with A-wave form can also be used for an inventive interior trim element 1. The webs 3 of different wave planes are here directly connected to adjacent webs, so that the cavities 6 would allow no pronounced movement of the air along the interior trim element 1. Apertures 7 are therefore configured on some webs, for example, as holes in the middle of the honeycomb core of the multilayered structure, or else close to the inner top layer 4 or the outer top layer 5 of the multilayered structure. The apertures 7 can be fluidically connected with both the cavities 6 of individual waves of a wave plane and the cavities 3 of different wave planes.

In FIG. 4, the use of the interior trim element 1 in a vehicle 8 is represented. The interior trim element 1 here forms a roofliner of the vehicle 8. The outflow openings 2 enable temperature-controlled air to be fed through the roofliner into the interior of the vehicle 8.

A roofliner can also be easily produced in non-planar form, such as for example, by the use of the known “crushed-core” process in which a planar honeycomb core is locally deformed by pressure influence and is held in shape by the top layers of the multilayered component.

Embodiments thus enable a particularly compact construction, as well as relatively low production costs for an apparatus for the air conditioning and/or ventilation of an interior of a vehicle.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An apparatus comprising:
an interior trim element on which are configured outflow openings configured to permit air to flow into an interior compartment of a vehicle for the air conditioning and/or ventilation of the interior, the interior trim element including a multilayered structure having a honeycomb core formed of webs between an inner top layer and an outer top layer, adjacent webs being spaced apart from each other to define cavities configured, the webs and cavities combining to form ducts which guide the air in the interior trim element.

2. The apparatus of claim 1, wherein the ducts are configured such that the air is guided normal to the multilayered structure of the interior trim element.

3. The apparatus of claim 1, wherein the ducts are fluidically connected to an air cooling/heating system.

4. The apparatus of claim 1, wherein the ducts are fluidically connected to an access path to external air from outside the vehicle.

5. The apparatus of claim 1, wherein the interior trim element comprises a vehicle roofliner.

6. The apparatus of claim 1, wherein the honeycomb core comprises a folding core.

7. The apparatus of claim 6, wherein the cavities of the folding core form continuous chambers, which extend substantially normal to the multilayered structure of the interior trim element.

8. The apparatus of claim 7, wherein the continuous chambers of the folding core are configured as ducts for the guidance of the air in the interior trim element.

9. The apparatus of claim 1, wherein the honeycomb core comprises an expansion wave core or as an A-wave core.

10. The apparatus of claim 1, wherein the honeycomb core comprises an A-wave core.

11. The apparatus of claim 1, further comprising apertures in the webs of the honeycomb core which are fluidically connected to the cavities of the honeycomb core.

12. The apparatus of claim 1, wherein the outflow openings are configured in the inner top layer of the multilayered structure.

13. The apparatus of claim 1, wherein the outflow openings are distributed over the entire surface of the interior trim element.

14. The apparatus of claim 1, wherein the outflow openings have different diameters.

15. The apparatus of claim 1, wherein the multilayered structure is covered on the inside with an air-permeable material.

16. The apparatus of claim 1, wherein the multilayered structure is covered on the inside with a perforated material.

17. The apparatus of claim 1, wherein the interior trim element comprises a part of a seat.

18. A motor vehicle comprising:
interior trim element on which are configured outflow openings configured to permit air to flow into an interior compartment of a vehicle for the air conditioning and/or ventilation of the interior, the interior trim element including:
an inner top layer;
an outer top layer spaced apart from the inner top layer;
webs extending in the space between the inner top layer and the outer top layer; and
a cavity formed between adjacent webs,
wherein the cavity and the webs define a duct configured to guide a flow of air in the interior trim element in a direction which is normal to the interior trim element.

19. An apparatus comprising:
interior trim element including:
an inner layer;
an outer layer spaced apart from the inner layer;
webs extending in the space between the inner layer and the outer layer; and
a cavity formed between adjacent webs, wherein the cavity and the webs define a duct configured to guide a flow of air in the interior trim element in a direction which is normal to the interior trim element; and
an outflow opening provided in the inner layer and configured to permit air to flow into an interior compartment for the air conditioning and/or ventilation of the interior compartment.

20. The apparatus of claim 19, wherein the interior trim element comprises a vehicle roofliner.
